(19) United States
(12) Patent Application Publication
(10) Pub. No.: US 2013/0238683 A1
(43) Pub. Date: Sep. 12, 2013

(54) METHOD, SYSTEM AND COMPUTER PROGRAM PRODUCT FOR PROVIDING FILES TO A CLIENT

(71) Applicant: OVERSI NETWORKS LTD., Petach Tikva (IL)

(72) Inventors: Ofer Wald, Petach Tikva (IL); Ayelet Wald, Petach Tikva (IL); Eyal Zohar, Shimshit (IL)

(73) Assignee: Oversi Networks Ltd., Petach Tikva (IL)

(21) Appl. No.: 13/748,639

(22) Filed: Jan. 24, 2013

Related U.S. Application Data
(63) Continuation of application No. 12/107,781, filed on Apr. 23, 2008.
(60) Provisional application No. 60/983,573, filed on Oct. 30, 2007.

(51) Int. Cl. H04L 29/08

(52) U.S. Cl. CPC H04L 67/104
USPC 709/202

(57) ABSTRACT

A method for providing information to a client over a peer-to-peer network, the method includes: receiving, by a tracker proxy, a re-directed first request of a client to access a tracker; and sending, by the tracker proxy, a first response that identifies a network cache as a peer. A method for providing a video file to a client, the method includes: receiving a request of a client to retrieve a video file from a web site or another external source out of multiple requests that are sent to multiple information sources; and providing to the client cache a first response that identifies a network cache as a source of the video file.

### RELATED APPLICATIONS

This application is a Continuation of and claims benefit from U.S. patent application Ser. No. 12/107,781, filing date Apr. 23, 2008, which in turn claims priority from U.S. provisional patent Ser. No. 60/983,573 filed on 30 Oct. 2007, both patent applications are being incorporated herein by reference.

### FIELD OF THE INVENTION

This application relates to methods, systems and computer program products for supporting peer-to-peer traffic and a provision of files over a client server network.

### BACKGROUND OF THE INVENTION

Internet service providers are required to support multiple file sharing and file retrieval protocols such as but not limited to peer-to-peer protocols, server client protocols and the like. Commonly used protocols include the BiTorrnt protocol, the eDonkey protocol and the like. Web sites such as www.youtube.com enable users to retrieve video files by applying video streaming technologies.

Peer-to-Peer protocols as well as various file retrieval protocols are not designed in a manner that optimizes resource utilization. Especially, there is no distinction between traffic between peers that belong to the same Internet Service Providers (ISP) networks and traffic between peers that belong to different ISP networks.

In addition, the downloading of files can relatively slow.

There is a growing need to improve the service provided to clients of an internet service provider (ISP) optimize network load and to reduce the cost of the services provided by an internet service provider.

### SUMMARY OF THE INVENTION

A system for providing information to a client over a peer-to-peer network, the system includes a tracker proxy, adapted to receive a re-directed first request of a client to access a tracker; and send a first response that identifies a network cache as a peer.

A computer program product that comprises a computer readable medium that stores instructions that when executed by a computer of a tracker proxy cause the computer to receive a re-directed first request of a client to access a tracker; and send a first response that identifies a network cache as a peer.

A method for providing information to a client over a peer-to-peer network, the method includes: (i) receiving, by a tracker proxy, a re-directed first request of a client to access a tracker; and (ii) sending, by the tracker proxy, a first response that identifies a network cache as a peer.

Conveniently, the method includes receiving a second request of the client to access the tracker; shortly after a receiving of the first request, and directing the second request to the tracker.

Conveniently, the time gap between the first and second request can be determined in advance and sent to the client.

Conveniently, the method can apply a closed garden policy and block requests to the tracker.

Conveniently, the first response further comprises timing information that encourages the client to send a second request to access the tracker a short period after the receiving of the first request.

Conveniently, the first response further comprises at least local peers and does not include any remote peers.

Conveniently, the first response comprises at least one local peer and at least one remote peer; wherein the at least one remote peer is associated with lower access priority in relation to the at least one local peer.

Intelligent response based on network weights—e.g. lower weights for users with lower uplinks or have a higher “network cost metric” related to distance, locality, peering, networking costs, users status, POP location, type of infrastructure, network load, etc. Conveniently, the method further includes concealing an existence of portions of a requested file at a local peer from the tracker.

Conveniently, the method includes updating local peer statistics.

Conveniently, the method includes generating an upload indication representative of the request of the local peer to upload information to the remote peer.

Conveniently, the method further includes sending the upload indication to at least one tracker.

Conveniently, the method includes generating a false upload completion indication that falsely indicates that the local peer completed the upload information to the remote peer.

Conveniently, the method includes sending false upload completion indication to at least one tracker.

Conveniently, the method further includes detecting that segments of a requested file are stored outside a local network; and delaying a response to a request to download the segments of the file.

Conveniently, the method further includes automatically finding popular trackers and ignoring a request of a client that is sent to a non-popular tracker.

Conveniently, the method further includes receiving popularity information indicative of popular trackers and ignoring a request sent to a non-popular tracker.

Conveniently, the method further includes automatically finding popular trackers and associating a low priority to a request of a client that is sent to a non-popular tracker.

Conveniently, the method further includes receiving popularity information indicative of popular trackers and associating a low priority to a request of a client that is sent to a non-popular tracker.

A system for providing information to a client over a peer to peer network, the system includes a tracker proxy, adapted to receive a re-directed request of a client to access a tracker; modify upload information of the request, by the tracker proxy, to provide a modifier request; and send, by the tracker proxy, the modified response to the tracker.

A computer program product that comprises a computer readable medium that stores instructions that when executed by a computer of a tracker proxy cause the computer to receive a re-directed request of a client to access a tracker; modify upload information of the request to provide a modifier request; and send the modified response to the tracker.

A method for providing information to a client over a peer to peer network, the method includes: (i) receiving, by a tracker proxy, a re-directed request of a client to access a tracker; (ii) modifying upload information of the request, by the tracker proxy, to provide a modifier request; and (iii) sending, by the tracker proxy, the modified response to the tracker.

Conveniently, the upload information is modified to conceal an existence of portions of a requested file at a client.

Conveniently, the method includes updating upload information indicative of uploads performed by the client.

Conveniently, the method includes generating an upload indication representative of a willingness of the client to upload information to the remote peer.

Conveniently, the method includes modifying the upload information to falsely indicate that the local peer completed an upload operation that was blocked by the tracker proxy.

A computer program product that comprises a computer readable medium that stores instructions that when executed by a computer of a file manager to receive a re-directed request of a client to retrieve a file from a web site out of multiple requests that are sent to multiple information sources; and provide to the client a first response that identifies a network cache as a source of the file.

A system for providing a video file or stream to a client, the system includes a video file manager, adapted to receive a re-directed request of a client to retrieve a file from a web site out of multiple requests that are sent to multiple information sources; and provide to the client a first response that identifies a network cache as a source of the file.

A method for providing a video file or stream to a client, the method includes: (i) receiving a re-directed request of a client to retrieve a file from a web site out of multiple requests that are sent to multiple information sources; and (ii) providing to the client a first response that identifies a network cache as a source of the file.

Conveniently, the received request is sent over a UDP protocol while at least one request of the multiple request is sent over a TCP protocol.

A system for providing a video file to a client, the system includes a video file manager that is adapted to receive a request of a client to retrieve a video file from a web site; and provide to the client the video file from a network cache; wherein web site information that differs from the video file is provided to the client from a web site server.

A computer program product that comprises a computer readable medium that stores instructions that when executed by a computer of a video file manager to receive a request of a client to retrieve a video file from a web site; and provide to the client the video file from a network cache; wherein web site information that differs from the video file is provided to the client from a web site server. For this purpose advertising information related to this video in unaltered or unharmed.

A method for providing a video file to a client, the method includes: (i) receiving a request of a client to retrieve a video file from a web site server; and (ii) providing to the client the video file from a network cache; wherein web site information that differs from the video file is provided to the client from the web site server.

Conveniently, the method includes storing in the network cache only video streams that fulfill an interest criterion.

Conveniently, the method includes generating statistics representative of requests to retrieve video streams. The statistics can related to multiple (or all) of the video streams that propagate through the ISP network and to multiple (or all) video web sites that are accessed through the ISP network.

Conveniently, the method includes imposing a bandwidth limitation on the providing to the client of the video stream. Conveniently, the method includes imposing access load, or to set a QoE level to match a tiered service (OTT video monetization).

Conveniently, the cache can add local advertising to the video—pre-roll, mid-roll, post-roll or overlay.

### BRIEF DESCRIPTION OF THE DRAWINGS

The present invention will be understood and appreciated more fully from the following detailed description taken in conjunction with the drawings in which:

FIG. 1 illustrates a system according to an embodiment of the invention;

FIG. 2 illustrates traffic according to an embodiment of the invention;

FIG. 3 illustrates a method according to an embodiment of the invention;

FIG. 4 illustrates a method according to an embodiment of the invention;

FIG. 5 illustrates a system and its environment according to an embodiment of the invention;

FIG. 6 illustrates a method according to an embodiment of the invention;

FIG. 7 illustrates a system for providing a video file to a client, and its environment according to an embodiment of the invention; and

FIG. 8 illustrates a method 500 according to an embodiment of the invention.

### DETAILED DESCRIPTION OF THE INVENTION

For simplicity of explanation, some of the following drawings will refer to the BitTorrent protocol and BitTorrent compliant architectures. It is noted that other protocols and other architectures can be provided without departing from the spirit of the invention.

Conveniently, a tracker proxy (also referred to as iTracker) is provided for pre-defined popular trackers. The determination of which trackers are popular is automatic and is based upon statistics of monitored traffic. The names of the popular trackers are not manually provided to the tracker proxy.

The tracker proxy can be configured into one or more routers of an ISP network. The tracker proxy can receive all (or a part of) communication from BitTorrent clients to a tracker, and can have multiple strategies to handle these requests.

The tracker proxy replies to “announce” messages with a response that includes a network cache as an information source (as a peer or even as a seed), giving the network cache some priority over peers outside the ISP network.

The following description refers to a router that can perform re-routing operations. Conveniently, a re-routing operation (executed, for example, by a deep packet inspection re-director) is equivalent to the re-routing.

### Peer to Peer Tracker Proxy

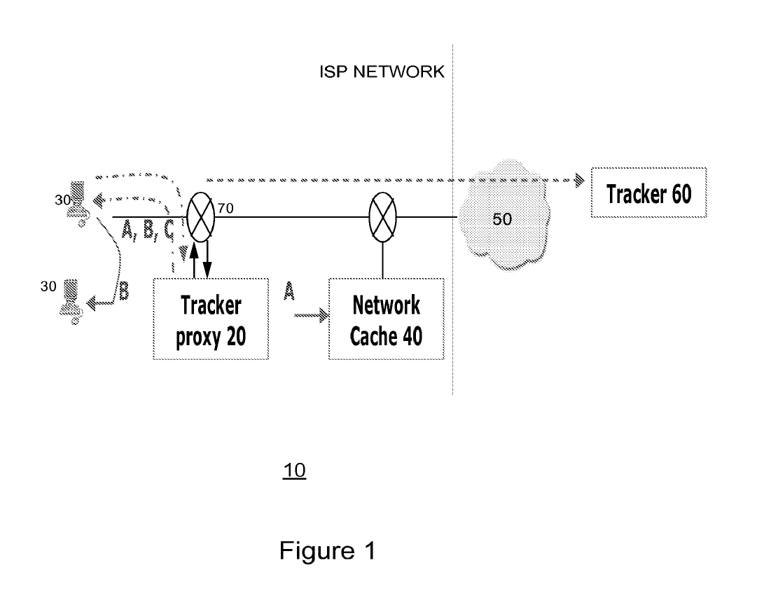

FIG. 1 illustrates system 10 according to an embodiment of the invention.

System 10 includes tracker proxy 20, two peers 30, router 70 and network cache 40. System 10 is included within an ISP network. The ISP network is connected to other (remote) peers and/or trackers such as tracker 60 via another network 50. Other network 50 can be an Internet backbone network.

Conveniently, when installed for a group of peers, the tracker proxy can transparently replace some of the trackers, and respond instead of these trackers for selected users/torrents/times.

In response to a request (from a client that belongs to the ISP network) to initiate a download of file segments, the tracker proxy can provide one or more responses. A first response (also referred to as an initial response) can include a list of local peers—peers that are located within the ISP network. The initial list can include network cache 40. Yet according to another embodiment of the invention, the initial list can include a combination of network cache 40, one or more local peers and one or more remote peers (peers that do not belong to the ISP network of the client that generated the initial request). Remote peers (also referred to as external peers) can be associated with lower access priority.

According to an embodiment of the invention, if the ISP network does not include a source of a requested file then an out of ISP policy can be applied. This policy can include refusing the first request to access the file, delaying the first request and then responding to the request with an initial list of peers that includes peers outside the ISP network, requesting the source of the request to repeat the provision of the request a short while after the refusal of a previous request and the like. The out of ISP policy can dynamically change.

Yet according to another embodiment of the invention, a peer can be prevented from receiving files from a source outside the ISP network or can be totally denied. This involves modifying a request of the peer before sending the modified request to a tracker, preventing the request from arriving to the tracker, providing a response that includes only local sources, and the like.

It is noted that if a peer is blocked then the tracker proxy can indicate that the peer requested to upload content or can otherwise generate synthetic upload/download statistics that can compensate that peer for this blocking. These two operations can involve modifying upload information associated with that peer.

According to an embodiment of the invention the tracker proxy does not need to receive packets from trackers, it does not alter any packets, and it only receives traffic to trackers.

The following describe various operational modes of tracker proxy 20.

The first mode is a tracker proxy-concealing mode. In this mode tracker proxy 20 hijacks all the packets that were originally designated to specific trackers, and transparently answers them. This can require a complete TCP connection management, from establishment to close. There are no forwarded packets, and therefore the operating mode is rigid. This mode is characterized by a simple installation, because tracker proxy never forwards. It is easy to understand and maintain.

The second mode is a selective service mode. In this mode tracker proxy 20 can also forward packets. It allows client 30 to establish the TCP connection with tracker 60, in order to selectively interfere if needed, according to the specific request later sent to tracker 60. It can also let the client to send some announce requests to the tracker to get other peers in case it is needed. In this mode any combination of clients/torrents/times can be served differently. Here are some examples for what tracker proxy 20 can do: (i) let some of the clients to operate normally (sent client requests to the trackers without modifying the client requests); (ii) hide a tracker (prevent the client request to get to the tracker but rather responding by tracker proxy 20) for torrents that are stored in network cache 40, (iii) measure the influence of tracker proxy 20 on the service provided to the clients by selective operation (of the tracker proxy 20) per client/torrent/time.

According to various embodiments of the invention tracker proxy 20 can be connected to a sniffer or to another information source that can provide tracker proxy 20 with popularity information. Tracker proxy 20 can also be connected to a cache tracker (not shown) that is aimed to direct traffic to network cache 40.

It is noted that when other peer to peer protocols are supported (such as iMule) tracker proxy 20 can be replaced by a secondary server proxy or can be connected to a secondary server proxy that can assist in supporting such peer to peer protocols. Peer to peer protocols (such as iMule) distribute peer information among multiple dedicated servers. When a peer wishes to download files from other peers is asks its primary dedicated server (the dedicated server to which it is logged in) for peer information and also asks others servers (so called secondary dedicated servers) for peer information. The secondary server proxy can receive redirected requests (aimed to a secondary dedicated server) and respond by providing peer information that indicates the network cache as a source of a desired file. It is noted that the secondary server proxy (also referred to as iDonkey) can manage encrypted peer to peed traffic by emulating the encryption process of the peer-to-peer traffic. The secondary server proxy can hijack peer-to-peer traffic and especially source requests.

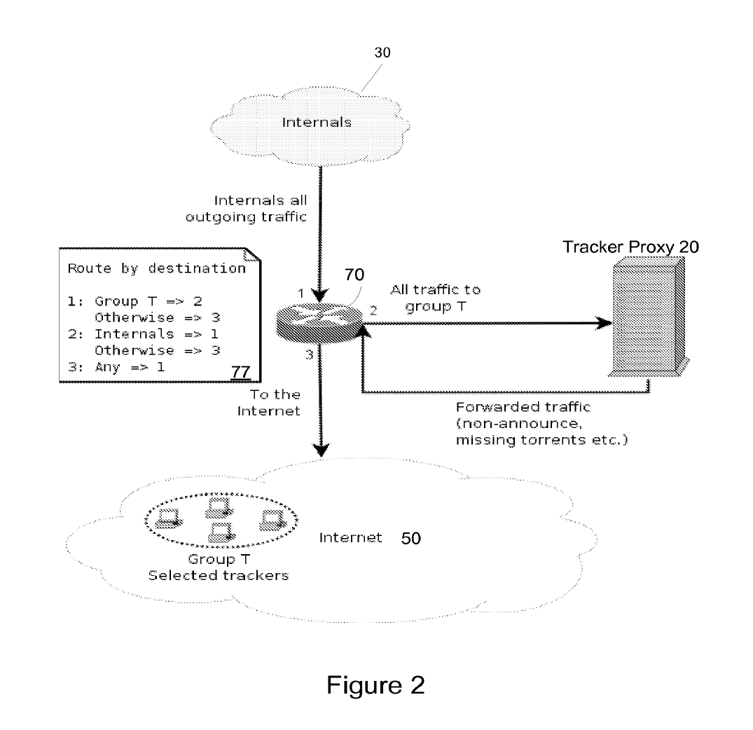

FIG. 2 illustrates a routing table 77 of router 70 of system 10 and an environment of system 10 according to an embodiment of the invention.

FIG. 2 illustrates routing table 77 that includes re-route instructions, based upon the entities included in the client request. Clients of the ISP network are referred to as internals while entities outside the ISP networks are referred to as externals.

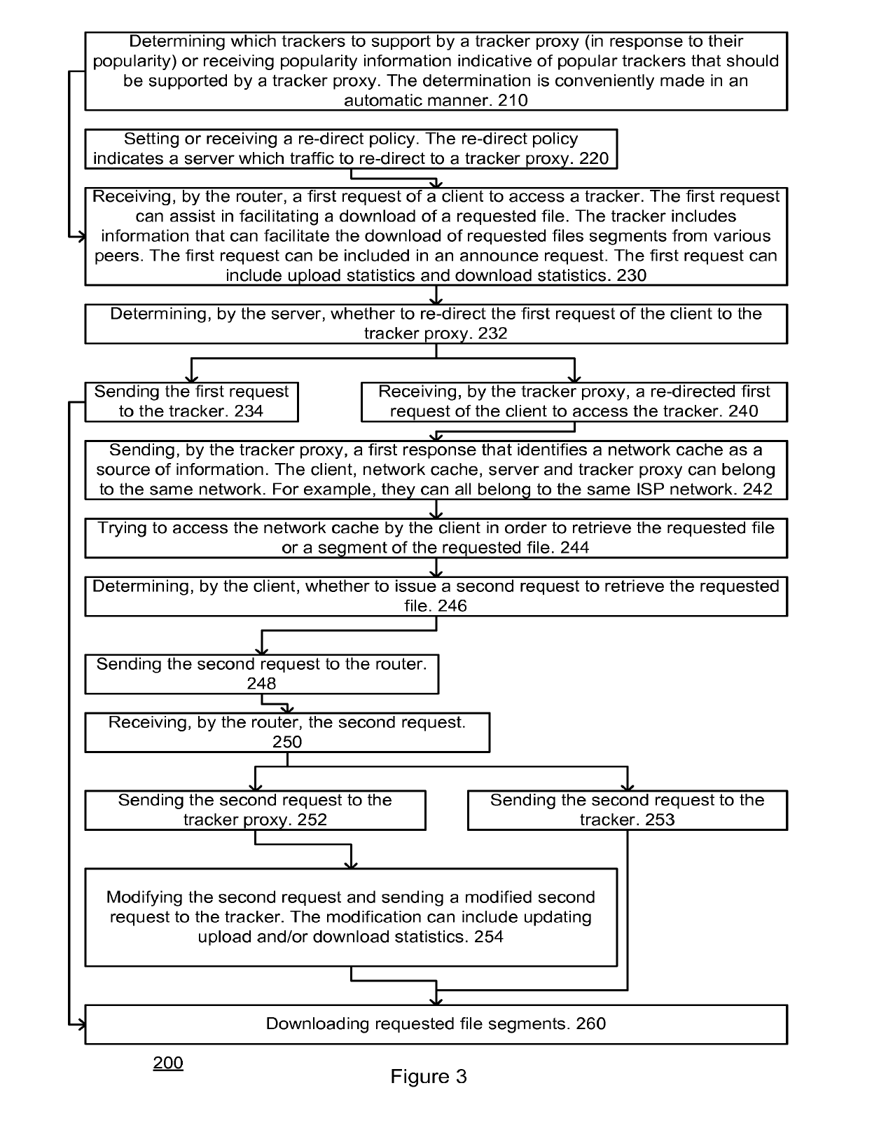

FIG. 3 illustrates method 200 according to an embodiment of the invention.

Method 200 starts by either one of stages stage 210 and 220 or a combination of both.

Stage 210 includes determining which trackers to support by a tracker proxy (in response to their popularity) or receiving popularity information indicative of popular trackers that should be supported by a tracker proxy. The determination is conveniently made in an automatic manner. The determination can be responsive to other (or additional) parameters that differ from the popularity of the tracker.

Stage 220 includes setting or receiving a re-direct policy. The re-direct policy indicates a server which traffic to re-direct to a tracker proxy. The re-direction policy can include an IP address range, or other characteristics of traffic to be re-directed to the tracker proxy. The re-direction policy can be fixed or dynamically changed. It is noted that the re-direction policy can include ignoring requests that are aimed to non-popular trackers.

Stage 210 and 220 are followed by stage 230 of receiving, by the router, a first request of a client to access a tracker. The first request can assist in facilitating a download of a requested file. The tracker includes information that can facilitate the download of requested files segments from various peers. The first request can be included in an announce request. The first request can include upload statistics and download statistics.

Stage 230 is followed by stage 232 of determining, by the server, whether to re-direct the first request of the client to the tracker proxy. If the answer is positive then stage 232 is followed by stage 240 else, stage 232 is followed by stage 234 of sending the first request to the tracker.

Stage 240 includes receiving, by the tracker proxy, a re-directed first request of the client to access the tracker.

Stage 240 is followed by stage 242 of sending, by the tracker proxy, a first response that identifies a network cache as a source of information. The client, network cache, server and tracker proxy can belong to the same network. For example, they can all belong to the same ISP network.

Stage 242 can include sending a first response that includes timing information that encourages the client to send a second request to access the tracker a short period after the receiving of the first request by the tracker proxy. This timing information actually reduces the penalty of a failed attempt to find the file at the network cache. Typically, a peer is asked to wait a substantial period between requests to the same tracker. By reducing this period the client can send the request to a tracker is the response to the first request failed as the network cache was not able to send to the client the requested file or substantially portions of the file.

Stage 242 is followed by stage 244 of trying to access the network cache by the client in order to retrieve the requested file or a segment of the requested file. When using a peer-to-peer protocol the network cache can appear as one of the peers. The network cache can provide information at higher rates than a regular peer and will inherently become a preferred peer for data downloads.

Stage 244 is followed by stage 246 of determining, by the client, whether to issue a second request to retrieve the requested file. The determination can be responsive to the success of retrieving the requested file or a substantial portion thereof from the network cache. The second request can be equal to the first request. The second request can be sent shortly after sending the first request, for example if timing information allows it.

Assuming that the client determined to issue a second request then stage 244 is followed by stage 248 of sending the second request to the router.

Stage 248 is followed by stage 250 of receiving, by the router, the second request.

Stage 250 can be followed by stage 251 of sending the second request to the tracker or can be followed by stage 252 of sending the second request to the tracker proxy. Stage 252 can be followed by stage 253 of sending the second request to the tracker or by stage 254 of modifying the second request and sending a modified second request to the tracker. The modification can include updating upload and/or download statistics. For example, inserting an indication that the peer was willing to upload information, updating the upload statistics to include

Stage 244, 251, and 253 can be followed by stage 260 of downloading requested file segments. Stage 260 can also include uploading requested file segments. It is noted that once the client communicates with other peers the tracker and the tracker proxy can left out of the picture.

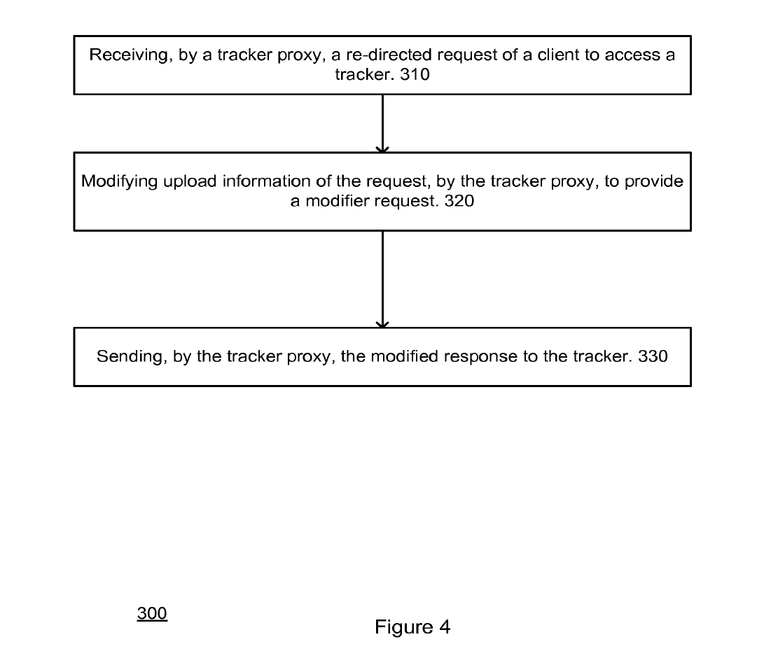

FIG. 4 illustrates method 300 according to an embodiment of the invention.

While FIG. 4 illustrates various stages that were executed by various entities such as a client, a router, a tracker proxy, and even a tracker, FIG. 3 illustrates the stages that are executed by the tracker proxy only. It is noted that the stages of method 300 can be followed or preceded by other stages that are executed by other entities. This can include, for example, a re-routing stage, a determination to send a request to a tracker, answering a client request by a tracker, establishing peer to beet connections and transferring (downloading and/or uploading) file segments.

Method 300 starts by stage 310 of receiving, by a tracker proxy, a re-directed request of a client to access a tracker.

It is noted that the requests can be generated in a repetitive manner by the client. These requests can be generated as long as the client did not receive the whole file or otherwise is still interested in participating in downloading and/or uploading segments of the file.

Stage 310 is followed by stage 320 of modifying upload information of the request, by the tracker proxy, to provide a modified request.

Stage 320 can include modifying the upload information to conceal an existence of portions of a requested file at a client.

Stage 320 can include updating upload information indicative of uploads performed by the client.

Stage 320 can include generating an upload indication representative of a willingness of the client to upload information to the remote peer.

Stage 320 can include modifying the upload information to falsely indicate that the local peer completed an upload operation that was blocked by the tracker proxy.

Stage 320 is followed by stage 330 of sending, by the tracker proxy, the modified response to the tracker.

Once stage 330 is completed, the tracker can respond to the modified upload information, other peers can exchange information with the client and the like.

It is noted that the tracker manages the exchange of file segments between peers. The tracker or the peers can apply a file exchange mechanism that is responsive to the amount of file segments that were uploaded and/or downloaded by the client. The modified upload information can affect this process.

### Peer to Peer File Manager in a Server Based Peer Information Distribution Network

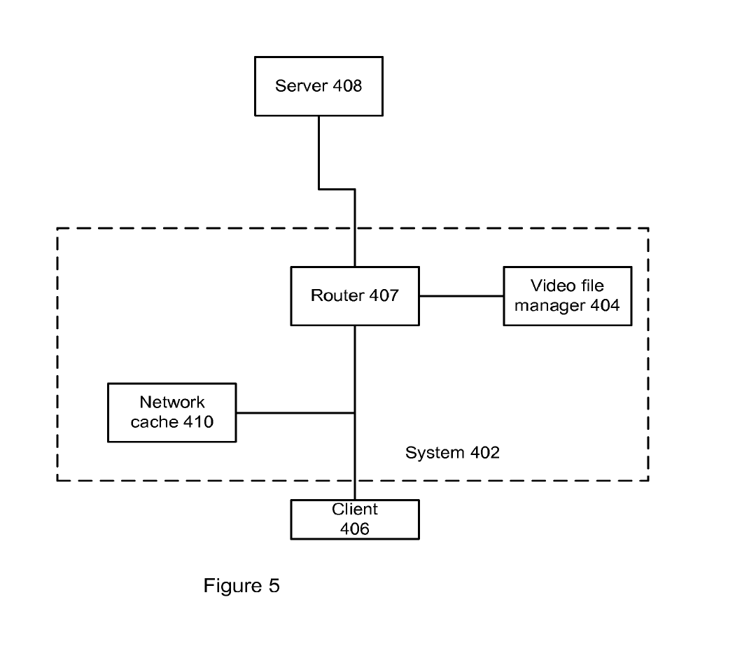

FIG. 5 illustrates system 402 and its environment according to an embodiment of the invention.

System 402 can support the eMule protocol or other file sharing protocol that uses an entity that differs from a tracker in order to control the file sharing.

The eMule protocol allows a client to initiate a search (initiated by a client) of a file name (or other file attributes such as the hash value of the file) in one or more dedicated servers. These dedicated servers store peer information that once retrieved by the client can be used by the client to receive file segments.

The dedicated servers are termed “dedicated” because they are a part of a dedicated network that acquires and distributes peer information. For example, such a dedicated server can be an iMule server.

A client is logged on to a primary dedicated server but also can receive information from secondary dedicated servers.

The client can receive multiple responses from multiple dedicated servers. Once receiving a response to that initial search the client can ask the dedicated server (that provided an initial response) where the other clients (peers) that use the same hash value. The server responds by providing peer information such as location information of these other clients. The dedicated server then asks these clients for the file.

System 402 includes file manager 404 that can be viewed as a server proxy. File manager 404 can be connected to client 406 and to router 407 via one or more networks or links. Router 407 can be connected to primary dedicated server 408 and to multiple secondary dedicated servers 409. Router 407 can re-direct to file manager 404 a request (such as an initial request) of a client that is directed.

File manager 404 is adapted to receive a re-directed request of a client (such as client 406) to retrieve a peer information from a secondary dedicated server and provide a response that indicates network cache 410 as a source of the file.

File manager 404 receives the request after the request is re-directed to it by router 407.

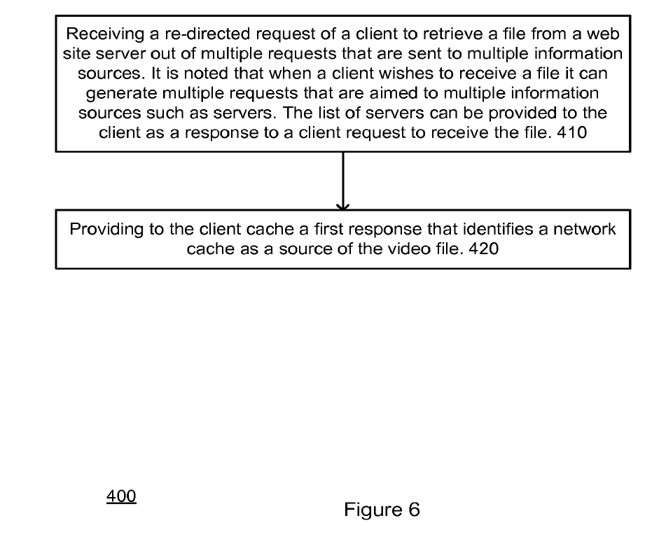

FIG. 6 illustrates method 400 according to an embodiment of the invention.

Method 400 starts by stage 410 of receiving a re-directed request of a client to retrieve peer information from a dedicated server out of multiple requests that are sent to multiple dedicated servers. Each of the dedicated servers stores peer information. Different peer information can store different peer information. The dedicated servers can include a primary dedicated server and a secondary dedicated server. The re-directing conveniently includes a request sent to a secondary dedicated server.

The request is re-directed to a file manager by a router.

Some of the requests can have higher priority then other requests and can be provided with over higher quality of service links.

Stage 410 is followed by stage 420 of providing to the client a first response that identifies a network cache as a source of the file.

Conveniently, the received request is sent over a UDP protocol while at least one request of the multiple requests is sent over a TCP protocol.

Monitoring TCP connections is complex and resource consuming. Accordingly, method 400 can involve monitoring only UDP connections, but this is not necessarily so.

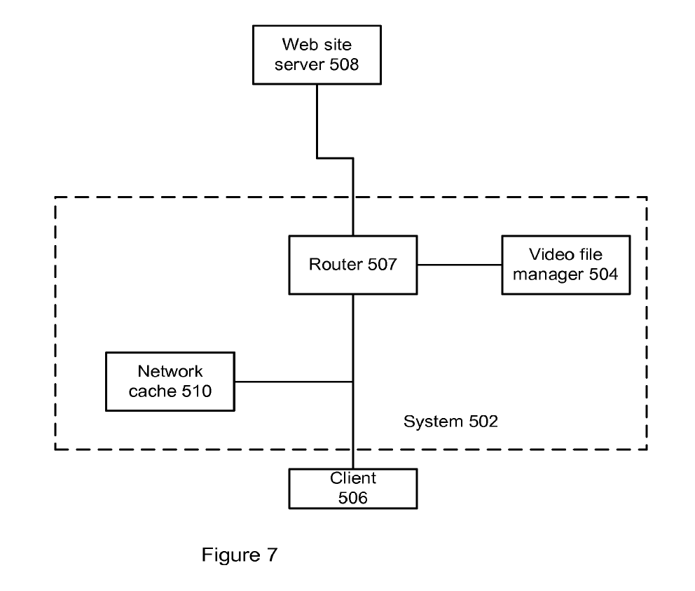

FIG. 7 illustrates system 502 for providing a video file to a client, and its environment according to an embodiment of the invention.

System 502 includes video file manager 504 that is adapted to receive a (re-directed) request of a client to retrieve a video file from a web site server such as web site server 508. The request is not sent to the web site server as it is intercepted and stopped by the video file manager 504. It is noted that the request can also be directed to another external source (outside the ISP network) that differs from a web site server.

Video file manager 504 is capable of controlling or initiating a provision to the client of the video file from network cache 510. Web site information that differs from the video file is provided to the client from web site server 508.

Typically, the other web site information is sent to the client before the client requests the video file.

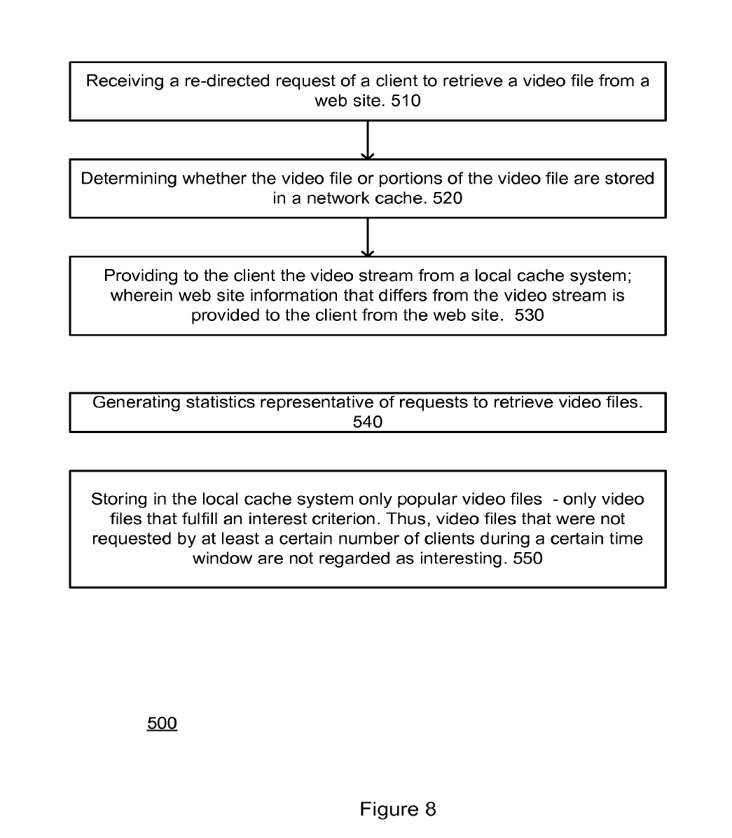

FIG. 8 illustrates method 500 according to an embodiment of the invention.

Method 500 starts by stage 505 of receiving requests from a client to receive web site information that differs from a video file and sending these requests (for example in a transparent manner) to the web site server.

Stage 505 can be followed by stage 510 of receiving a re-directed request of a client to retrieve a video file from a web site.

Stage 510 is followed by stage 520 of determining whether the video file or portions of the video file are stored in a network cache.

If the answer is positive then stage 520 can be followed by stage 530 of providing to the client the video stream from a network cache; wherein web site information that differs from the video stream is provided to the client from the web site. Thus, while the video file itself is provided from a network cache the web site servers can send to the user information that will cause the client to view the video stream embedded in the video file within the frame of the www.youtube.com web site. Thus, the client will not be aware that the video file is not provided from the www.youtube.com servers.

Stage 520 can include imposing a bandwidth limitation on the providing to the client of the video stream. Thus, the overall amount of bandwidth allocated for retrieving video files can be limited.

Stage 520 can be preceded by stages 530 and 540.

Stage 530 includes generating statistics representative of requests to retrieve video files.

Stage 540 includes storing in the network cache only popular video files—only video files that fulfill an interest criterion. Thus, video files that were not requested by at least a certain number of clients during a certain time window are not regarded as interesting.

Method 500 can further be clarified by the following example. A client wishes to log into a web site such as www.youtube.com. The client establishes a TCP connection with the server of www.youtube.com, and exchanges TCP packets with that server. As a result of this exchange the computer of the client can display the www.youtube.com portal as well as information that allow the user to view a video file. The viewing can involve utilizing video streaming technology.

Once the client wished to view a video file it (especially its media player) sends a unique request over the TCP connection. This unique request is answered by video file manager 504 and not sent to the web site server. The response includes providing information that enables the client to receive the video file from network cache 510.

Video files can be downloaded to network cache before receiving a request to receive these video files or in response to such requests. Thus, network cache 510 can operate in a back-to-back manner in which it sends to the user portions of the video file while receiving the video file from the web site server.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Although the invention has been described with respect to specific conductivity types or polarity of potentials, skilled artisans appreciated that conductivity types and polarities of potentials may be reversed.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

Also, devices functionally forming separate devices may be integrated in a single physical device.

However, other modifications, variations and alternatives are also possible. The specifications and drawings are, accordingly, to be regarded in an illustrative rather than in a restrictive sense.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may further be a data connection, such as a telephone cable or a wireless connection.

Conveniently a computer program product is provided. It includes a computer readable medium that stores instructions that when executed by a computer of a tracker proxy causes the computer to receive a re-directed first request of a client to access a tracker; and send a first response that identifies a network cache as a peer. The term “a computer of a tracker proxy” can refer to a computer that executed the tracker proxy, to a computer that belongs to a tracker proxy unit, and the like.

Conveniently a computer program product is provided. It includes a computer readable medium that stores instructions that when executed by a computer of a tracker proxy cause the computer to receive a re-directed request of a client to access a tracker; modify upload information of the request to provide a modifier request; and send the modified response to the tracker.

Conveniently a computer program product is provided. It includes a computer readable medium that stores instructions that when executed by a computer of a file manager to receive a re-directed request of a client to retrieve a file from a web site out of multiple requests that are sent to multiple information sources; and provide to the client a first response that identifies a network cache as a source of the file.

Conveniently a computer program product is provided. It includes a computer readable medium that stores instructions that when executed by a computer of a video file manager to receive a request of a client to retrieve a video file from a web site; and provide to the client the video file from a network cache; wherein web site information that differs from the video file is provided to the client from a web site server.

In the claims, the word ‘comprising’ does not exclude the presence of other elements or steps then those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to advantage.

1. A method for providing information to a client over a peer to peer network, the method comprising:
receiving, by a tracker proxy, a re-directed request of a client to access a tracker;
modifying upload information of the request, by the tracker proxy, to provide a modifier request; and
sending, by the tracker proxy, the modified response to the tracker.

2. The method according to claim 1 wherein the upload information is modified to conceal an existence of portions of a requested file at a client.

3. The method according to claim 1 comprising updating upload information indicative of uploads performed by the client.

4. The method according to claim 1 comprising generating an upload indication representative of a willingness of the client to upload information to the remote peer.

5. The method according to claim 1 comprising modifying the upload information to falsely indicate that the local peer completed an upload operation that was blocked by the tracker proxy.

6-11. (canceled)

12. A system for providing information to a client over a peer to peer network, the system includes a tracker proxy, adapted to receive a re-directed request of a client to access a tracker; modify upload information of the request, by the tracker proxy, to provide a modifier request; and send, by the tracker proxy, the modified response to the tracker.

13. The system according to claim 12 wherein the tracker proxy is adapted to modify the upload information to conceal an existence of portions of a requested file at a client.

14. The system according to claim 12 wherein the tracker proxy is adapted to update upload information indicative of uploads performed by the client.

15. The system according to claim 12 wherein the tracker proxy is adapted to generate an upload indication representative of a willingness of the client to upload information to the remote peer.

16. The system according to claim 12 wherein the tracker proxy is adapted to modify the upload information to falsely indicate that the local peer completed an upload operation that was blocked by the tracker proxy.

17-22. (canceled)

23. A computer program product that comprises a computer readable medium that stores instructions that when executed by a computer of a tracker proxy cause the computer to receive a re-directed request of a client to access a tracker; modify upload information of the request to provide a modifier request; and send the modified response to the tracker.

24. The computer program product according to claim 23 wherein the upload information is modified to conceal an existence of portions of a requested file at a client.

25. The computer program product according to claim 23 that stores instructions that when executed by a computer of a tracker proxy causes the computer to update upload information indicative of uploads performed by the client.

26-31. (canceled)
